(19) United States
(12) Patent Application Publication
(10) Pub. No.: US 2024/0256997 A1
(43) Pub. Date: Aug. 1, 2024

(54) REDUCED PROCESSING CALL-TO-ACTION GENERATION USING PROGRESSIVE FILTERING

(71) Applicant: GONG.io Ltd., Ramat Gan (IL)

(72) Inventors: Barak HAREL, Kfar Sava (IL); Efrat EZRA, Ramat Gan (IL); Inbal COHEN, Tel Aviv (IL); Nethanel DYKSTEIN, Herzliya (IL); Noaa Victoria ILANI, Tel Aviv (IL); Ortal ASULIN, Rosh Ha'ayin (IL); Ran MOCHARY, Ness-Ziona (IL); Victoria AIZENBERG, Netanya (IL); Shlomi MEDALION, Lod (IL)

(73) Assignee: GONG.io Ltd., Ramat Gan (IL)

(21) Appl. No.: 18/162,509

(22) Filed: Jan. 31, 2023

(51) Int. Cl. G06Q 10/0631; G06Q 10/109; H04L 51/212

(52) U.S. Cl. CPC G06Q 10/06311; G06Q 10/109; H04L 51/212

(57) ABSTRACT

A system and method for efficiently generating calls-to-action using progressive filtering. A method includes determining whether messages are eligible or ineligible for response, wherein determining whether each message is eligible or ineligible for response further includes applying eligibility rules defining criteria for determining that a message requires further action. A first set of filtered messages is created by filtering each message which is determined to be ineligible for response. The first set of filtered messages is clustered into clusters based on contents of the first set of filtered messages. Redundant tasks are identified in at least one first cluster. A second set of filtered messages is created by filtering a portion of the at least one first cluster including the redundant tasks. Calls-to-action are generated based on the second set of filtered messages.

### TECHNICAL FIELD

The present disclosure relates generally to providing automated calls-to-action to users, and more specifically to improving efficiency of call-to-action systems using progressive filtering.

### BACKGROUND

Customer service representatives, account executives, sales development representatives, customer success managers, and other business-to-customer (B2C) and business-to-business (B2B) representatives rely on following up with customers or potential customers in order to achieve their goals. Manually setting reminders and follow ups can be incredibly cumbersome, particularly when each employee is engaged in a high volume of calls requiring such follow ups. Some solutions for automating reminders exist. However, these solutions face challenges in processing the exponential amount of message data being generated on a daily basis. Moreover, many such solutions often apply naïve rules for setting reminders, which either provide too few reminders (thereby missing potentially fruitful conversations) or too many reminders (thereby defeating the purpose of such an automated system and overwhelming employees with low value reminders). Solutions can utilize more complex rulesets and/or machine learning in order to improve accuracy, but these measures require more computing resources.

Solutions for improving the efficiency and accuracy of automated calls-to-action are therefore highly desirable. In particular, solutions which allow for reducing the amount of computing resources needed to be devoted to processing high volumes of data are desirable.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for efficiently generating calls-to-action using progressive filtering. The method comprises: determining whether each message of a plurality of messages is eligible or ineligible for response, wherein determining whether each message is eligible or ineligible for response further comprises applying eligibility rules defining at least one criteria for determining that a message requires further action; creating a first set of filtered messages by filtering each message which is determined to be ineligible for response in order to create a first set of filtered messages; clustering messages of the first set of filtered messages into a plurality of clusters based on contents of the first set of filtered messages; identifying at least one redundant task in at least one first cluster of the plurality of clusters; creating a second set of filtered messages by filtering, from the first set of filtered messages, at least a portion of the at least one first cluster including the identified at least one redundant task; and generating at least one call-to-action based on the second set of filtered messages.

Certain embodiments disclosed herein also include a non-transitory computer readable medium having stored thereon causing a processing circuitry to execute a process, the process comprising: determining whether each message of a plurality of messages is eligible or ineligible for response, wherein determining whether each message is eligible or ineligible for response further comprises applying eligibility rules defining at least one criteria for determining that a message requires further action; creating a first set of filtered messages by filtering each message which is determined to be ineligible for response in order to create a first set of filtered messages; clustering messages of the first set of filtered messages into a plurality of clusters based on contents of the first set of filtered messages; identifying at least one redundant task in at least one first cluster of the plurality of clusters; creating a second set of filtered messages by filtering, from the first set of filtered messages, at least a portion of the at least one first cluster including the identified at least one redundant task; and generating at least one call-to-action based on the second set of filtered messages.

Certain embodiments disclosed herein also include a system for efficiently generating calls-to-action using progressive filtering. The system comprises: a processing circuitry; and a memory, the memory containing instructions that, when executed by the processing circuitry, configure the system to: determine whether each message of a plurality of messages is eligible or ineligible for response, wherein determining whether each message is eligible or ineligible for response further comprises applying eligibility rules defining at least one criteria for determining that a message requires further action; create a first set of filtered messages by filtering each message which is determined to be ineligible for response in order to create a first set of filtered messages; cluster messages of the first set of filtered messages into a plurality of clusters based on contents of the first set of filtered messages; identify at least one redundant task in at least one first cluster of the plurality of clusters; create a second set of filtered messages by filtering, from the first set of filtered messages, at least a portion of the at least one first cluster including the identified at least one redundant task; and generate at least one call-to-action based on the second set of filtered messages.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for generating calls-to-action according to an embodiment.

FIG. 3 is a flowchart illustrating a method for progressively filtering data according to an embodiment.

FIG. 4 is a flowchart illustrating a method for classifying messages with respect to broadcasting status according to an embodiment.

FIG. 5 is a flow diagram illustrating classification of messages with respect to broadcasting status.

FIG. 6 is a schematic diagram of a call-to-action generator according to an embodiment.

### DETAILED DESCRIPTION

The various disclosed embodiments include methods and systems for efficiently processing message data in order to generate calls-to-action using progressive filtering. The disclosed embodiments filter message data to remove redundant messages, irrelevant messages, or otherwise messages which do not require follow ups. Moreover, the progressive filtering used herein allows for filtering in stages, with one filtering stage being used to improve the next. In particular, the filtering may be performed using less computing resource-intensive processes in earlier stages and more accurate but more computing resource-intensive processes in later stages in order to conserve resources by applying more resource-intensive filtering to only a limited subset of the message data.

In at least some embodiments, the progressive filtering includes filtering based on content of messages. The filtering based on content may include, but is not limited to, an initial filtering stage which includes determining whether messages are eligible for calls-to-action using an eligibility filtering criteria, as well as a subsequent filtering stage which includes clustering messages based on similarity in content and filtering out all but a limited set (e.g., a single message) within each cluster. The cluster-based filtering may be performed, for example, using machine learning, based on distances (e.g., Levenshtein distances), based on predetermined message tags, combinations thereof, and the like. The subsequent filtering stage may further include one or more additional filtering processes such as, but not limited to, rate-based filtering based on rates of message sequences.

In yet a further embodiment, the rate-based filtering, the cluster-based filtering, or both, may be performed using machine learning by applying one or more machine learning models. A rate-based machine learning model may be trained to, for example, identify anomalous or otherwise high rates of messages within a sequence so as to filter out additional messages beyond a first message within a sequence. Moreover, the rate-based machine learning model may be trained for a particular user, for example, using supervised machine learning based on a training data set including labeled data with labels representing users to which different portions of data belong. In this regard, the rate-based filtering may be performed by identifying, using the rate-based machine learning model, sequences of messages from a particular user within a given timeframe which demonstrate an abnormally high rate such that the messages in the sequence are likely part of the same conversation and therefore are unlikely to require multiple calls-to-action.

When the clustering is performed using machine learning, the clustering-based machine learning model may be trained to, for example, cluster messages based on similarities in content and to filter messages from among each cluster. For example, machine learning may be utilized to cluster messages with respect to information indicated among the content such as, but not limited to, topics of conversation, other entities mentioned in the conversation (e.g., people, companies, etc.), key terms (e.g., business terms or other terms related to specific topics), combinations thereof, and the like.

The disclosed embodiments may, among other things, be utilized as part of a digital assist tool in order to provide representatives of an organization handling large amounts of message data with reminders and other calls-to-action in order to ensure that those representatives achieve their goals (e.g., sales goals, recruitment goals, etc.). Further, in addition to the technical benefits related to efficiently processing data and conserving computing resources, the disclosed embodiments may be utilized to filter redundant or otherwise unnecessary message data, thereby creating fewer tasks for representatives. This can be utilized to reduce the amount, size, or both, of notifications to those representatives.

It is noted that generating calls-to-action in a naïve manner (e.g., based solely on identification of certain key terms within messages) may result in generating a number of calls-to-action which are overwhelming for users. Consequently, users may stop responding to or otherwise acting upon those calls-to-action, thereby defeating the purpose of automatically reminding users to follow up on conversations. For the reasons noted above, the disclosed embodiments can be utilized to efficiently arrive at a minimized number of calls-to-action, thereby conserving computing resources for generating such calls-to-action and sparing users from excessive reminders.

Moreover, even hypothetical solutions which take into account rate in order to reduce the amount of calls-to-action (e.g., by filtering out messages sent or received within a certain timeframe) may result in filtering out messages due to false positives for rate-based filtering conditions caused by messages being within the same timeframe even though those messages may relate to different potential tasks or otherwise different calls-to-action. The disclosed embodiments which utilize a combination of rate-based and clustering-based filtering further solve the challenges related to false positives for filtering messages based on rate.

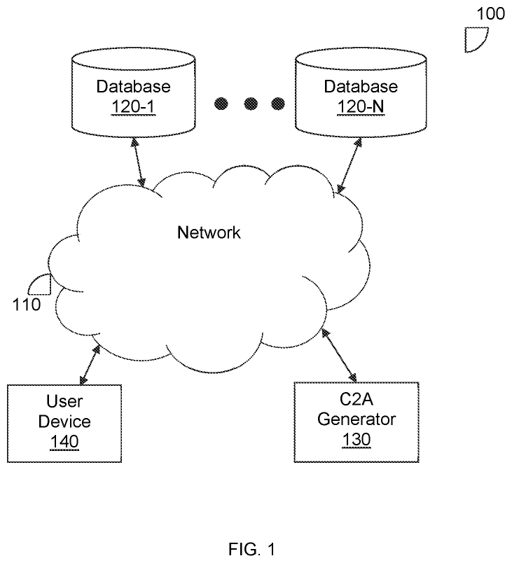

FIG. 1 shows an example network diagram 100 utilized to describe the various disclosed embodiments. In the example network diagram 100, a plurality of databases 120-1 through 120-N (hereinafter referred to individually as a database 120 and collectively as databases 120, merely for simplicity purposes), a call-to-action (C2A) generator 130, and a user device 140 communicate via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The databases 120 store message data which may be related to conversations, for example but not limited to, between customers and company representatives. Such message data may include, but is not limited to, call logs, call recordings, electronic mail (email) messages, chat logs, instant messages, or other audio, text, or data otherwise including contents of communications or content related to communications between and among individuals. The messages may be realized as types of communications such as, but not limited to, web conference calls, phone calls, emails, short message service (SMS) messages, text messages, instant messages, social media posts, combinations thereof, portions thereof, and the like. Such message data may therefore include messages for which it is desirable to follow up, for example, in order to complete a sale or to provide assistance. As noted above, a significant amount of such message data may be generated in any given day, particularly for large call centers with hundreds or thousands of employees.

The call-to-action generator 130 is configured to process the message data in the databases 120 and to generate calls-to-action using the processed message data in accordance with the various disclosed embodiments. In particular, the call-to-action generator 130 is configured to perform a multi-stage filtering process in order to reduce the amount of message data which may require calls-to-action in order to reduce the total amount of data to be processed for determining calls-to-action. Moreover, the progressive filtering may start at lower granularity at earlier stages and only proceed to consider higher granularity filtering factors in order to further improve the efficiency of the filtering. In an embodiment, the multi-stage filtering may be based on rate of messages and clustering of messages.

The user device (UD) 140 may be, but is not limited to, a personal computer, a laptop, a tablet computer, a smartphone, a wearable computing device, or any other device capable of receiving and displaying notifications indicating calls-to-action. The user device 140 may receive calls-to-action generated by the call-to-action generator 130 in order to prompt a user (not shown) of the user device 140 to follow up or otherwise perform some action in response to communications represented in the message data.

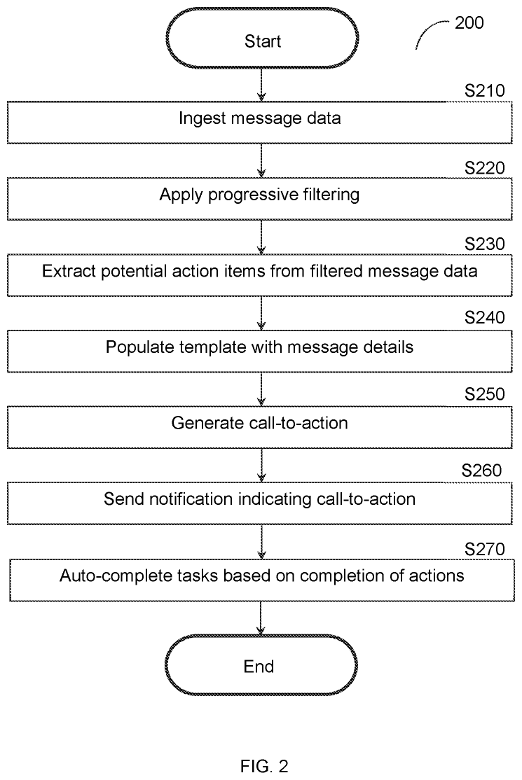

FIG. 2 is a flowchart 200 illustrating a method for generating calls-to-action according to an embodiment. In an embodiment, the method is performed by the call-to-action generator 130, FIG. 1.

At S210, message data is ingested. The message data may be ingested, for example, from one or more data sources (e.g., one or more of the databases 120, FIG. 1) storing data related to communications. Such communications may include, for example but not limited to, electronic mails (emails), calls (i.e., audio message data), call logs instant messages, texts, combinations thereof, and the like. In an example implementation, the message data may be messages between customer service representatives and customers or potential customers for which follow up tasks (such as calling the customer again after an initial meeting) may be desirable. As noted above, the vast amount of message data which might be ingested in a larger call center presents challenges in processing efficiently.

In some embodiments, S210 may further include processing the message data for subsequent use. As a non-limiting example, audio message data may be analyzed using automated speech recognition (ASR) techniques in order to generate a transcript for a call or other audio message, and the transcript may be utilized for subsequent processing. Additionally, message data may be cleaned, normalized, or otherwise prepared for subsequent use.

At S220, a progressive filtering process is applied to the ingested message data in order to create a set of filtered message data.

The progressive filtering at least includes an initial filtering stage and one or more subsequent filtering stages. In an embodiment, the initial filtering stage is a content-based filtering including checking whether each message among the message data is eligible for a call-to-action. Messages that are not eligible for calls-to-action (e.g., messages which do not mention actionable items) are filtered out during the initial filtering stage. The subsequent filtering stages include another content-based filtering stage performed by clustering messages with respect to content and filtering out at least some of the messages within each cluster.

The subsequent filtering stages may further include a rate-based filtering stage performed by analyzing message rates (e.g., a rate at which messages are sent between or among entities) and identifying a sequence of messages with a high rate (e.g., above a threshold rate for a given time period or that is determined to be abnormally high by applying a machine learning model) and filtering out at least some of the messages in each identified sequence.

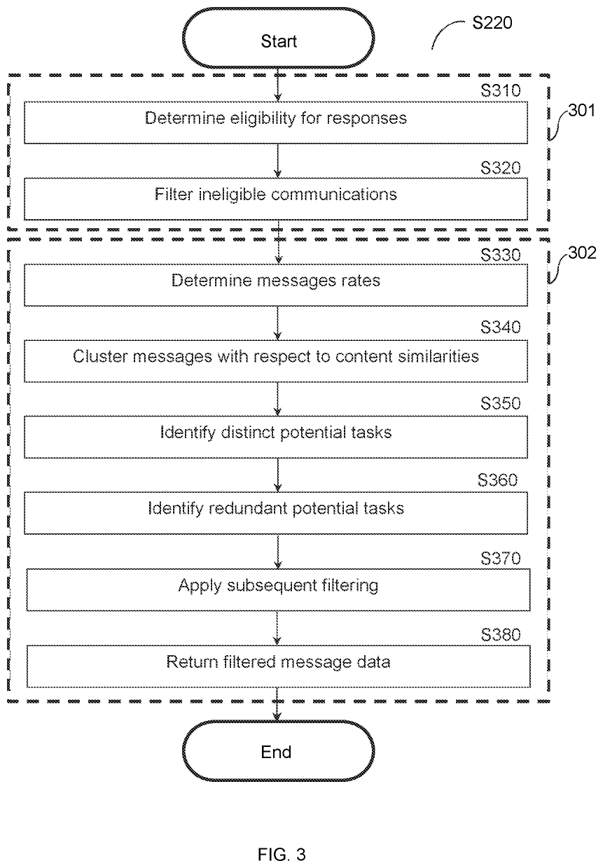

In an embodiment, the progressive filtering is performed as now described with respect to FIG. 3. FIG. 3 is a flowchart S220 illustrating a method for progressively filtering data according to an embodiment.

At S310, during an initial filtering stage 301, eligibility for responses is determined for each of a plurality of messages included among message data (e.g., the message data ingested at S210). In an embodiment, S310 includes applying one or more eligibility rules defining eligibility criteria. The eligibility rules may require, for example but not limited to, appearance of one or more known terms or phrases indicative of messages requiring further action (e.g., the terms “touch base”, “circle back”, “follow up”, “talk again”, etc.).

At S320, ineligible communications (i.e., communications which are not determined as eligible for responses) are filtered out from among the message data. The result is a first set of filtered message data including messages which may potentially require a call-to-action. By initially filtering out messages which do not require calls-to-action in a less computing resource-intensive process (e.g., by applying rules which require basic identification of predetermined key terms or a machine learning model trained on a smaller feature space used for checking eligibility than the feature space of the machine learning model used for clustering), subsequent filtering steps can be performed more efficiently since the amount of message data to be analyzed in more computing-intensive filtering steps is reduced. That is, the initial filtering stage requires fewer computing resources (e.g., processing power) than one or more of the filtering steps during the subsequent stage (e.g., clustering-based filtering), thereby conserving computing resources as compared to only performing the subsequent stage.

At S330, during a subsequent filtering stage 302, message rates are determined based on the remaining messages. In an embodiment, S330 includes detecting sequences of messages originating from a common user (e.g., a sequence of emails sent by the same user) within a given timeframe such that the sequence includes messages demonstrating at least a threshold rate. The rate may be defined with respect to, for example, a number of messages sent within a particular period of timeframe (e.g., 5 messages within a timeframe of 1 minute beginning with the first of the five messages and ending with the fifth message). The rate threshold used for detecting sequences at S330 may be predetermined or may be learned using machine learning, and may be set per user, per group of users, per organization, and the like. As noted above, using rate alone may result in yielding false positives for messages to be filtered. Accordingly, in various disclosed embodiments, the rate-based analysis is utilized in one or more content-based filtering analyses (e.g., the clustering analysis performed at S340) in order to avoid false positives.

At S340, messages are clustered with respect to similarities in content among the messages. In an embodiment, the clustering is performed via a machine learning model trained to cluster messages with respect to content of those messages. By clustering messages in this manner, messages which are related to the same subject (e.g., the same conversation which requires the same follow up action) can be identified in order to filter out redundant messages by removing some messages related to the same subject (i.e., filtering out some of the messages within each cluster).

At S350, distinct potential tasks indicated among the messages are identified. In an embodiment, S350 includes identifying at least one message in each cluster for which a call-to-action could be generated. In a further embodiment, the distinct potential tasks may be determined based on rate. For example, the results of the rate-based analysis and the results of the clustering-based analysis may be scored via weighted scoring, and utilized to generate scores for each pair of messages indicating redundancy between the pair of messages. In an example implementation, one of the messages among a group of messages having redundancy scores with each other above a threshold may be identified as a distinct potential task, and other messages in the group may be identified as redundant potential tasks.

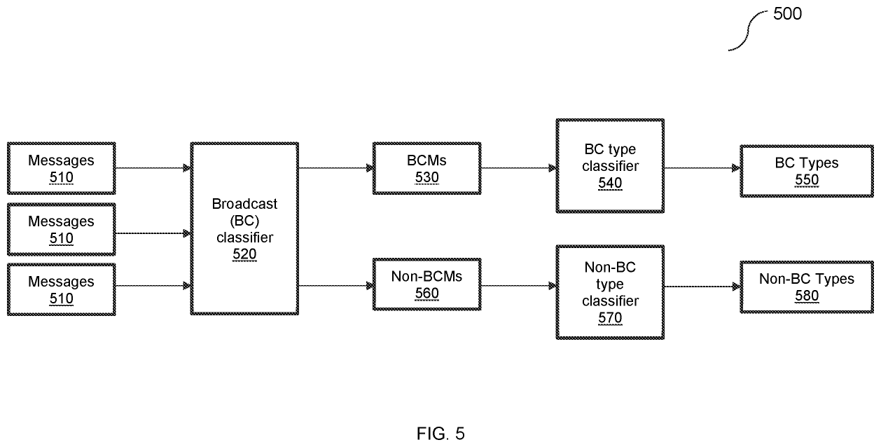

In some embodiments, some of the distinct potential tasks may be identified based on messages which were filtered out during the rate-based filtering. That is, messages sent as part of the same broadcast as determined based on rate may be analyzed for potential tasks, and any potential tasks identified among those messages filtered out based on rate may be identified as distinct potential tasks. In other words, messages which are not part of a broader communication broadcast are likely to be related to distinct potential follow ups, so any tasks related to such messages can be determined as distinct tasks with a high degree of confidence without requiring analyzing the content of those messages further. To this end, S350 may include applying a broadcast classifier (e.g., the broadcast classifier 520, FIG. 5) or may otherwise include utilizing results of broadcast classification in order to improve efficiency of identifying distinct potential tasks with respect to the messages filtered out based on rate.

At S360, redundant tasks among the identified potential tasks are filtered. The redundant tasks may be, for example, any messages identified as redundant potential tasks or which are any messages other than messages identified as distinct potential tasks at S350.

As noted above, the analyses performed at S340, S350, or both, are more computer resource-intensive than the analysis performed during the initial filtering stage 301, thereby conserving computing resources by performing a deep dive only on messages which more clearly require calls-to-action. This, in turn, allows for providing a scalable filtering process which can be deployed in larger organizations with exponentially more message data to process. Moreover, the combination of rate and cluster-based analyses allows for more accurately identifying redundant potential tasks, thereby allowing for generating fewer notifications (or notifications with less data) and minimizing disruption to users who will receive such notifications.

At S370, one or more additional filtering steps may be applied. Various examples of additional filtering steps which may be performed are now discussed.

In an embodiment, S370 may include applying an advanced eligibility-based filtering process. The advanced eligibility-based filtering process utilizes more computing resources than the eligibility-based filtering process performed during the initial filtering stage and may be, but is not limited to, performed using a machine learning model with a larger feature space (which, consequently, requires more computing resources in order to perform analysis) than a machine learning model utilized during the initial filtering process, or using more complex rules (e.g., requiring checking more conditions or for which the conditions to be checked require more analysis than the conditions from the initial filtering stage) in order to determine whether any of the remaining messages actually require action. Alternatively or collectively, the basic analysis may be limited in scope with respect to which portions of data in each message are checked (e.g., only metadata and headers), while the advanced analysis may involve analyzing additional parts of the message (e.g., the body of the message).

That is, the initial filtering stage may utilize a basic eligibility-based filtering process which results in more false negatives (i.e., determining not to filter out certain messages) than the advanced eligibility-based filtering, and the advanced eligibility analysis may be performed on a limited subset of the total message data to determine if any of the remaining messages actually require a response as defined with respect to one or more advanced eligibility checking conditions. This further conserves computing resources by reducing the amount of message data to be processed using such an advanced analysis.

At S380, a set of filtered message data (i.e., message data remaining after the filtering steps discussed above) is returned to be used during subsequent processing. As a non-limiting example, the filtered message data may be analyzed and utilized to generate calls-to-action as discussed further below with respect to FIG. 2.

Returning to FIG. 2, at S230, potential action items are extracted from the filtered message data. Extracting the action items may include, but is not limited to, applying one or more action item extraction rules, applying one or more machine learning model trained to classify message data as either action items or not action items, both, and the like.

At optional S240, a template is populated with message details. The template may be a message template including pre-completed message data. As a non-limiting example, an email template having pre-filled text may be populated with conversation-specific data extracted from the message data (e.g., subject of the conversation, names of other participants in the conversation, etc.). The pre-filled text of such an example email template may include, for example, language such as “Following up on our previous call, I am checking in to see if you would like to discuss . . . ”

Alternatively, S240 may include creating at least a portion of a personalized message, for example using one or more text generation algorithms based on previous communications with the recipient, data indicating information about the recipient or about a subject of the message, messages sent to other recipients in similar situations (e.g., at the same stage of communications such as initial contact, discussions about a particular product, discussions about a meeting, or closing), transcripts for other communications with the recipient, combinations thereof, and the like. The personalized message or portion thereof may be proposed to a potential sender of the message, or may be utilized to generate suggestions for auto-completing or rephrasing certain portions of a message being drafted by the potential sender.

At S250, one or more calls-to-action are generated based on the filtered message data. The calls-to-action may include, but are not limited to, reminders to follow up or otherwise communicate in relation to each message remaining in the filtered message data. In some implementations, the calls-to-action may include communicating via one or more communication mediums (e.g., email, instant message, private message, text message, call, etc.) determined based on the filtered message data (e.g., calls-to-action including a call-to-action involving sending an email may be generated when the message data for which the call-to-action is generated includes an email).

The calls-to-action may be generated by applying one or more call-to-action generation rules defining when to generate calls-to-action, types of calls-to-action for different potential tasks, whether to generate proposed content (e.g., prefilled templates or automatically drafted messages) when notifying a user of a call-to-action, formatting for any calls-to-action, whether to first propose calls-to-action and seek user feedback or whether to generate calls-to-action without user input, combinations thereof, and the like. Moreover, the call-to-action generation rules may be predefined and may be defined per user, per organization, combinations thereof, portions thereof, and the like. Even further, the call-to-action generation rules may be defined at least partially based on user inputs, thereby allowing the user to set preferences regarding calls-to-actions being generated for the user. As a non-limiting example, a user who works remotely on Monday and Friday may prefer to receive calls-to-action on days when they are in the office, and so the user may select call-to-action generation rules which only send notifications with calls-to-action to that user on Tuesday, Wednesday, or Thursday.

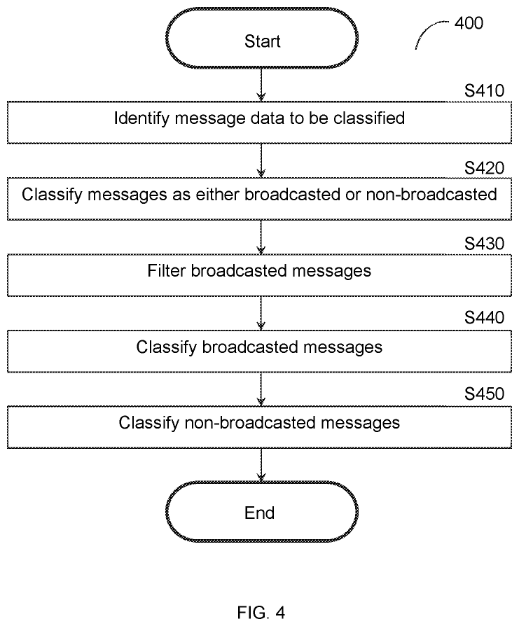

In some embodiments, S250 further includes classifying the messages, where the calls-to-action are generated based on the classifications. To this end, S250 may include, but is not limited to, classifying each message into broadcasted messages or non-broadcasted messages, classifying messages into specific types of broadcasted or non-broadcasted messages, both, and the like. Messages may be classified as either broadcasted or non-broadcasted based on factors such as, but not limited to, rate, number of recipients, similarities in content, combinations thereof, and the like. Example techniques for classifying messages with respect to broadcast status are described further below with respect to FIGS. 4-5.

It should be noted that the classification of messages with respect to broadcast types is mentioned here as a possible sub-step for S250 merely for simplicity purposes, and that part or all of such classification may be performed in parallel with other steps or otherwise prior to S250 in at least some implementations. Further, as discussed below, classifying messages with respect to broadcast status may allow for further filtering messages, which therefore can be integrated in combination with the above filtering steps without departing from the scope of the disclosure. As a non-limiting example, broadcast status classifications may be performed at least partially at or before S330 and utilized to aid in filtering during the subsequent filtering stage.

At S260, one or more notifications are sent based on the generated calls-to-action. The notifications may include, but are not limited to, text or other content indicating the calls-to-action, names of entities to contact as part of the called upon actions, contact information for such entities, any pre-populated templates (e.g., as described per S240 above), an interactive object (e.g., a button) which causes a template to be automatically populated upon interaction, deadlines for completing each call-to-action (e.g., either an arbitrary deadline such as within 1 week of the date of the last conversation or as determined based on contents of the messages such as a message saying “let's touch base in early January”), combinations thereof, portions thereof, and the like. In an example implementation, the notification is received as a popup message or as part of a digest presented to a user on their user device.

In an embodiment, S260 further includes determining a time for sending the notification (i.e., a time for notifying the user of each call-to-action). The time for sending the notification may be determined using one or more notification timing rules, which may be predetermined or may be determined, for example, using machine learning for a given user. As a non-limiting example for a predetermined notification timing rule, a notification may be sent one (1) week after the last message in a sequence of messages. As a non-limiting example for notification timing determined via machine learning, it may be determined that a particular user tends to work on calls-to-action on Monday mornings at 10 AM local time, so a notification may be sent at 10 AM local time in order to provide the calls-to-action at a time when the user is most likely to act upon them promptly.

The notification rules may further be defined with respect to contents of messages. As a non-limiting example, when a message states “I will check on this and get back to you in 3 weeks”, a notification with the call-to-action for this message may be timed for around 3 weeks from when the message is sent. Alternatively or in combination, the notification rules may include rules defined with respect to replies to messages. As a non-limiting example, when an email received as a reply to an initial email includes an out-of-office (OOO) message stating “OOO until next month,” the notification with the call-to-action for the initial email message may be timed for the following month.

In a further embodiment, some of the notifications may be filtered by applying one or more notification filtering rules. The notification filtering rules may filter notifications based on factors such as, but not limited to, types of notifications, frequencies of notifications (i.e., based on times determined for sending each notification), targets for calls-to-action represented in the notifications (e.g., customers or potential customers). As a non-limiting example, when multiple notifications to be delivered within the same fortnight period (i.e., two weeks) share a target in the form of the same potential customer for which the call-to-action prompts the user to follow up with, the notifications may be combined into a single notification or otherwise some of the notifications to be sent regarding the same customer in that day may be filtered out.

In various embodiments, different types of notifications may be utilized. As a non-limiting example, a nudge type of notification may appear as a popup on a user device of a user, and an email reminder type of notification may be sent to an email inbox of the user. To this end, some types of notifications may be filtered more than others depending on how intrusive those types of notifications are. As a non-limiting example, if the calls-to-action result in generating 10 popup notifications to be delivered within 5 minutes, at least some of these popup notifications may be filtered in order to minimize interruptions to the user and increase the likelihood that the user responds to the notifications. Some or all of the filtered out notifications may optionally be converted into other types of notifications. As a non-limiting example, text of popup notifications may be utilized to populate email messages, and the email messages are sent as email reminder notifications. Additionally, multiple types of notifications generated for the same call-to-action (e.g., a follow up with the same potential customer) may be filtered out such that only one type of notification is sent for the user with respect to that call-to-action.

At optional S270, one or more tasks may be auto-completed (i.e., automatically marked as completed) based on completion of one or more actions corresponding to action items (e.g., the extracted potential action items) indicated in the call-to-action. To this end, S270 may include checking a list of tasks and determining that one or more actions required by tasks in the list have been completed. As a non-limiting example, a task of “follow up with John Smith via email” on a list of tasks may be automatically completed when an action of sending an email to “john.smith@mail.com” has been performed. Such a list of tasks may be created, for example but not limited to, by adding each call-to-action generated for a particular user or group of users to a task list dataset associated with that user or group of users.

FIG. 4 is an example flowchart 400 illustrating a method for classifying messages with respect to broadcasting status according to an embodiment. In an embodiment, the method is performed by the call-to-action generator 130.

At S410, message data to be classified is identified. The identified message data may be, but is not limited to, message data which has been filtered using progressive filtering as discussed above.

At S420, messages among the message data are classified as either broadcasted or non-broadcasted messages. To this end, S420 may include, but is not limited to, applying a machine learning broadcast classifier (e.g., the broadcast classifier 520, FIG. 5) trained to classify messages as either broadcasted or non-broadcasted based on features such as, but not limited to, message rate, number of recipients of each message, and similarities between text of messages.

At optional S430, messages classified as broadcasted may be filtered. In an embodiment, S430 includes grouping the broadcasted messages into broadcast groups, determining similarities between messages within each broadcast group, and filtering out messages from each broadcast group which demonstrate a similarity below a threshold with other messages in the broadcast group.

To this end, S430 may include grouping the broadcasted messages into broadcast groups, where each broadcast group includes broadcasted messages which were sent around the same time as each other (e.g., within a threshold time) or otherwise collectively meet one or more broadcast group criteria. In other words, messages related to the same broadcast of multiple messages sent as a unit (e.g., a blast email message sent to 100 recipients, where each recipient is sent one of 100 messages at adjacent times as indicated by their respective timestamps) are grouped into broadcast groups.

Once messages have been grouped into broadcast groups, the messages within each broadcast group may be analyzed to determine similarities in content between them. To this end, S430 may further include clustering messages based on their contents and filtering out messages which do not fall into any of the clusters, calculating distances between pairs of messages (e.g., a Levenshtein distance) and filtering out messages in each broadcast group demonstrating similarity below a threshold (e.g., having an average distance with other messages in the broadcast group that is below a threshold or having at least a certain number of messages in the same broadcast group with which the calculated distance is below a threshold). By analyzing similarity in this manner and filtering out messages accordingly, messages which are not actually broadcasted can be identified and filtered out to avoid further processing.

At S440, the broadcasted messages are classified into broadcast message types. In an example implementation, such broadcast message types include content not requiring response messages (e.g., messages containing news, journals, webinars, articles, etc.) and templated sales development representative (SDR) cold emails. In an embodiment, S440 includes applying a broadcast type classifier which may be, but is not limited to, a machine learning model trained to classify broadcasted messages into predetermined broadcast message types using a training set including training features derived from text in training messages.

At S450, the non-broadcasted messages are classified into non-broadcast message types. In an example implementation, such non-broadcast types 580 include personalized SDR cold emails, out-of-office (OOO) messages, and other types of messages for which follow ups are desired. In an embodiment, S450 includes applying a non-broadcast type classifier which may be, but is not limited to, a machine learning model trained to classify non-broadcasted messages into predetermined non-broadcast message types using a training set including training features derived from any of text of training messages, predetermined message templates, comparison results between training message text and text of predetermined message templates, level of familiarity with a recipient of training messages (e.g., representing a number of messages sent to or received from the same entity as the recipient of a given training message), connections to then-existing live opportunities (i.e., opportunities for follow ups represented in training data such as other training messages for which calls-to-action were generated), combinations thereof, and the like.

FIG. 5 is an example flow diagram 500 illustrating classification of messages with respect to broadcasting status.

As shown in FIG. 5, messages 510 are input to a broadcast classifier 520. The broadcast classifier may be or may include, but is not limited to, a machine learning classifier trained to classify messages into either broadcasted or not. The classification by the broadcast classifier may be based on factors such as, but not limited to, rate (i.e., a rate of messages including a given message), number of recipients for each message, similarities between messages (e.g., based on content of messages), combinations thereof, and the like. The broadcast classifier 520 classifies messages into broadcasted messages (BCMs) 530 and non-broadcasted messages (non-BCMs) 560.

Further, in some embodiments (not depicted in FIG. 5), the broadcasted messages 530 output by the broadcast classifier 520 may further be filtered in order to avoid subsequent processing of those filtered out broadcast messages. To this end, the broadcasted messages 530 may be grouped into one or more broadcast groups (not shown), where each broadcast group includes broadcasted messages sent as part of the same broadcast (e.g., messages that were sent within a threshold period of time as each other). The broadcast groups may be determined, for example, by clustering the messages with respect to times of sending. Similarities between messages in each such broadcast group may be determined, and messages with a similarity below a threshold to the other messages in the same broadcast group (e.g., a message which has a similarity below a threshold with a threshold number of other messages in the broadcast group) may be filtered out.

As a non-limiting example, the Levenshtein distance may be calculated between pairs of messages in each broadcast group, and a message which has a Levenshtein distance below a threshold with 2 or more other messages in the broadcast group may be filtered out. In this regard, messages which are determined to likely be part of the same broadcast but which do not have similar content (i.e., thereby indicating that they are not actually part of the same broadcasted message) may be removed from broadcast groups in order to make subsequent processing more efficient and accurate. In a further embodiment, the determined similarities may be validated using techniques such as, but not limited to, a text classifier.

The broadcasted messages 530 (or features extracted therefrom) are input to a broadcast (BC) type classifier 540 in order to determine respective broadcast types 550 for each of the broadcasted messages 530. In an example implementation, such broadcast types 550 include content not requiring response messages (e.g., messages containing news, journals, webinars, articles, etc.) and templated sales development representative (SDR) cold emails. The broadcast type classifier 540 may be, but is not limited to, a machine learning model trained to classify broadcasted messages into broadcast message types based on text in the messages, metadata (e.g., email headers), predetermined message templates, combinations thereof, and the like.

The non-broadcasted messages 560 (or features extracted therefrom) are input to a non-broadcast type classifier 570 in order to determine respective non-broadcast types 580 for each of the non-broadcasted messages 560. In an example implementation, such non-broadcast types 580 include personalized SDR cold emails, out-of-office (OOO) messages, and other types of messages for which follow ups are desired. The non-broadcast type classifier 570 may be, but is not limited to, a machine learning model trained to classify non-broadcasted messages into non-broadcast message types based on factors such as text in the messages, metadata (e.g., email headers), predetermined message templates (and, more specifically, based on degree of similarity between message templates and contents of messages), level of familiarity with the recipient (e.g., based on a number of past messages sent to or received from the recipient), any connections to existing live opportunities (i.e., potential sales or other opportunities which might require follow ups), combinations thereof, and the like.

The broadcast types 550 and the non-broadcast types 580 may be used to generate calls-to-action with respect to messages such as by determining whether to generate a call-to-action, a type of call-to-action to generate, a timing for a call-to-action, a number of reminders that should be generated for the call-to-action, a combination thereof, and the like. In this regard, it is noted that different types of messages may either not require follow ups or may get better results if follow ups are presented with certain timing or frequency. Generating calls-to-action based on broadcast status (e.g., broadcasted or non-broadcasted), and moreover generating calls-to-action based on certain types of broadcasted and non-broadcasted messages, therefore allows for more accurately generating calls-to-action in a manner that improves the chances of those calls-to-action resulting in successful follow ups (e.g., follow ups that yield responses, lead to sales, or otherwise obtain desirable results).

More specifically, messages containing content not requiring responses such as news, journals, articles, webinars, and the like, generally do not require follow ups as such content is generally not intended to lead directly to sales or comparable responses. Accordingly, it may be desirable to avoid generating calls-to-action for messages containing such content which does not require a response. Templated SDR cold emails (i.e., messages drafted primarily using standard or stock language) may be sent en masse or otherwise to a large number of recipients, and therefore it may be desirable to follow up on such templated cold emails only in certain circumstances. Personalized SDR cold emails (i.e., cold emails which were not drafted primarily using standard or stock language) are generally intended to seek a response from a particular user and, therefore, will generally be worth following up on. Out-of-office messages received in response to SDR messages may warrant follow ups, but success of those follow ups will be maximized if the call-to-action is generated so as to remind the SDR to follow up when the recipient is back in the office (e.g., based on a return date indicated in the OOO message). Any other messages in a general follow up category may be predetermined types of messages or defined by a particular entity, and generally warrant a follow up such that a call-to-action should be generated for such messages.

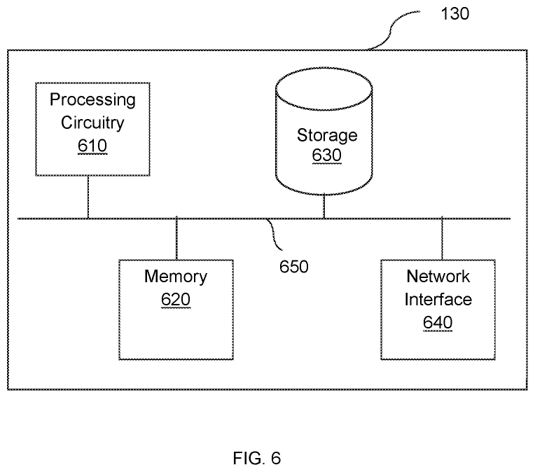

FIG. 6 is an example schematic diagram of a call-to-action generator 130 according to an embodiment. The call-to-action generator 130 includes a processing circuitry 610 coupled to a memory 620, a storage 630, and a network interface 640. In an embodiment, the components of the call-to-action generator 130 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 640 allows the call-to-action generator 130 to communicate with, for example, the databases 120, the user device 140, and the like.

It should be understood that the embodiments described herein are not limited to the specific architecture illustrated in FIG. 4, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for efficiently generating calls-to-action using progressive filtering, comprising:
determining whether each message of a plurality of messages is eligible or ineligible for response, wherein determining whether each message is eligible or ineligible for response further comprises applying eligibility rules defining at least one criteria for determining that a message requires further action;
creating a first set of filtered messages by filtering each message which is determined to be ineligible for response in order to create a first set of filtered messages;
clustering messages of the first set of filtered messages into a plurality of clusters based on contents of the first set of filtered messages;
identifying at least one redundant task in at least one first cluster of the plurality of clusters;
creating a second set of filtered messages by filtering, from the first set of filtered messages, at least a portion of the at least one first cluster including the identified at least one redundant task; and
generating at least one call-to-action based on the second set of filtered messages.

2. The method of claim 1, wherein creating the first set of filtered messages utilizes fewer computing resources than creating the second set of filtered messages.

3. The method of claim 1, further comprising:
extracting at least one action item from the second set of filtered messages, wherein the at least one call-to-action is generated for each of the extracted at least one action item.

4. The method of claim 3, further comprising:
marking at least one task as completed based on completion of at least one action corresponding to the extracted at least one action item.

5. The method of claim 1, further comprising:
populating each of at least one template with a plurality of message details based on the second set of filtered messages; and
generating at least one notification for the at least one call-to-action, wherein the generated at least one notification includes the populated at least one template.

6. The method of claim 1, wherein the first set of filtered messages is created using a basic filtering process, further comprising:
filtering at least one message from the second set of filtered messages in order to create a third set of filtered messages using an advanced filtering process, wherein the advanced filtering process utilizes more computing resources than the basic filtering process.

7. The method of claim 1, further comprising:
classifying each message of the second set of filtered messages into a broadcasting classification based on rate, number of recipients, and content similarities, wherein the at least one call-to-action is generated based further on the broadcasting classification.

8. The method of claim 7, wherein each message classified into a broadcasting classification is classified as a broadcasted message or a non-broadcasted message, further comprising:
classifying at least some of the broadcasted messages into a broadcast type classification; and
classifying each non-broadcasted message into a non-broadcast type classification, wherein the at least one call-to-action is generated based further on each broadcast type classification and each non-broadcast type classification.

9. The method of claim 8, further comprising:
grouping broadcasted messages among the second set of filtered messages into at least one broadcast group based on a time associated with each broadcasted message;
calculating distances between messages within each broadcast group; and
filtering at least one of the broadcasted messages based on the calculated distances in order to create a filtered set of broadcast messages, wherein broadcast type classifications are only determined for messages of the filtered set of broadcast messages.

10. A non-transitory computer readable medium having stored thereon instructions for causing a processing circuitry to execute a process, the process comprising:
determining whether each message of a plurality of messages is eligible or ineligible for response, wherein determining whether each message is eligible or ineligible for response further comprises applying eligibility rules defining at least one criteria for determining that a message requires further action;
creating a first set of filtered messages by filtering each message which is determined to be ineligible for response in order to create a first set of filtered messages;
clustering messages of the first set of filtered messages into a plurality of clusters based on contents of the first set of filtered messages;
identifying at least one redundant task in at least one first cluster of the plurality of clusters;
creating a second set of filtered messages by filtering, from the first set of filtered messages, at least a portion of the at least one first cluster including the identified at least one redundant task; and
generating at least one call-to-action based on the second set of filtered mess.

11. A system for efficiently generating calls-to-action using progressive filtering, comprising:
a processing circuitry; and
a memory, the memory containing instructions that, when executed by the processing circuitry, configure the system to:
determine whether each message of a plurality of messages is eligible or ineligible for response, wherein determining whether each message is eligible or ineligible for response further comprises applying eligibility rules defining at least one criteria for determining that a message requires further action;
create a first set of filtered messages by filtering each message which is determined to be ineligible for response in order to create a first set of filtered messages;
cluster messages of the first set of filtered messages into a plurality of clusters based on contents of the first set of filtered messages;
identify at least one redundant task in at least one first cluster of the plurality of clusters;
create a second set of filtered messages by filtering, from the first set of filtered messages, at least a portion of the at least one first cluster including the identified at least one redundant task; and
generate at least one call-to-action based on the second set of filtered mess.

12. The system of claim 11, wherein creating the first set of filtered messages utilizes fewer computing resources than creating the second set of filtered messages.

13. The system of claim 11, wherein the system is further configured to:
extract at least one action item from the second set of filtered messages, wherein the at least one call-to-action is generated for each of the extracted at least one action item.

14. The system of claim 13, wherein the system is further configured to:
mark at least one task as completed based on completion of at least one action corresponding to the extracted at least one action item.

15. The system of claim 11, wherein the system is further configured to:
populate each of at least one template with a plurality of message details based on the second set of filtered messages; and
generate at least one notification for the at least one call-to-action, wherein the generated at least one notification includes the populated at least one template.

16. The system of claim 11, wherein the first set of filtered messages is created using a basic filtering process, wherein the system is further configured to:
filter at least one message from the second set of filtered messages in order to create a third set of filtered messages using an advanced filtering process, wherein the advanced filtering process utilizes more computing resources than the basic filtering process.

17. The system of claim 11, wherein the system is further configured to:
classify each message of the second set of filtered messages into a broadcasting classification based on rate, number of recipients, and content similarities, wherein the at least one call-to-action is generated based further on the broadcasting classification.

18. The system of claim 17, wherein each message classified into a broadcasting classification is classified as a broadcasted message or a non-broadcasted message, wherein the system is further configured to:
classify at least some of the broadcasted messages into a broadcast type classification; and
classify each non-broadcasted message into a non-broadcast type classification, wherein the at least one call-to-action is generated based further on each broadcast type classification and each non-broadcast type classification.

19. The system of claim 18, wherein the system is further configured to:
group broadcasted messages among the second set of filtered messages into at least one broadcast group based on a time associated with each broadcasted message;
calculate distances between messages within each broadcast group; and
filter at least one of the broadcasted messages based on the calculated distances in order to create a filtered set of broadcast messages, wherein broadcast type classifications are only determined for messages of the filtered set of broadcast messages.
